(19) United States
(12) Patent Application Publication
(10) Pub. No.: US 2026/0147807 A1
(43) Pub. Date: May 28, 2026

(54) GRAPH-BASED CONTEXT RETRIEVAL FOR LARGE LANGUAGE MODELS

(71) Applicant: Adobe Inc., San Jose, CA (US)

(72) Inventors: Nedim LIPKA, Campbell, CA (US); Yu WANG, Eugene, OR (US); Tong SUN, San Ramon, CA (US); Ryan ROSSI, San Jose, CA (US); Ruiyi ZHANG, Mountain View, CA (US); Ashutosh MEHRA, Noida (IN); Alexa SIU, Sunnyvale, CA (US)

(73) Assignee: Adobe Inc., San Jose, CA (US)

(21) Appl. No.: 18/957,257

(22) Filed: Nov. 22, 2024

(51) Int. Cl. G06F 16/33; G06F 16/383

(52) U.S. Cl. CPC G06F 16/3344; G06F 16/3334; G06F 16/383

(57) ABSTRACT

Embodiments are disclosed for context retrieval for document question answering. The method may include obtaining a plurality of digital documents and dividing the plurality of digital documents into a plurality of document chunks. A similarity between each of the plurality of document chunks is determined. A multi-document graph is constructed based on the similarity between each of the plurality of document chunks. The multi-document graph includes a plurality of nodes representing the plurality of document chunks.

### BACKGROUND

Document Question Answering (DQA) is a machine learning task in which a user asks a natural language question about a document and receives a natural language answer. Typically, a user may provide the document and the question to a DQA model which then processes the question and the document to determine the answer. Various machine learning models may be used for document question answering, such as a pretrained language model (PLM), large language model (LLM), or other model. DQA systems return a natural language answer to the received question. This may take the form of a chat bot, smart assistant, etc.

### SUMMARY

Introduced here are techniques/technologies that use a graph to retrieve a context which includes portions of multiple documents to be used for document question answering (DQA). DQA models generate an answer to an input question based on a context. The context may include all or portions of the text of the document(s) being queried. Embodiments selectively generate that context by traversing a graph which represents chunks of the document(s). For example, a document management system includes a document manager which divides the document(s) into chunks. These chunks can represent portions (e.g., sentences, paragraphs, sections, etc.) of text from the documents. The graph is then generated by a graph construction manager such that each chunk is represented by a node of the graph, and the nodes are linked based on the similarity of the chunks to one another. In some embodiments, the graph may further include nodes that represent structural elements (e.g., tables, charts, page numbers) and/or metadata associated with the documents.

In some embodiments, when a query is received, a graph search manager can identify a starting node in the graph. This may be identified based on similarity between the query and the starting node. The graph can then be intelligently traversed to add relevant chunks of the documents to the context. For example, a passage generator can predict what the next chunk will be that will contribute to answering the question. The predicted next chunk can then be compared to the chunks that are connected to the current node and the most similar chunk can be added to the context. This traversal may continue until the question has been answered and/or the graph has been fully traversed or until another end condition has been reached (e.g., based on latency, a fixed number of steps, etc.).

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of knowledge graph construction in accordance with one or more embodiments;

FIG. 2 illustrates a diagram of knowledge graph construction based on keywords in accordance with one or more embodiments;

FIG. 3 illustrates a diagram of knowledge graph construction based on keywords, document embeddings, or document structure in accordance with one or more embodiments;

FIG. 4 illustrates a diagram of a process of document question answering using a document knowledge graph for context retrieval in accordance with one or more embodiments;

FIG. 5 illustrates an example of training a passage generator based on passage sequences in accordance with one or more embodiments;

FIG. 6 illustrates an example of a user interface for document question answering in accordance with one or more embodiments;

FIG. 7 illustrates a schematic diagram of document management system in accordance with one or more embodiments;

FIG. 8 illustrates a flowchart of a series of acts in a method of knowledge graph generation for context retrieval for document question answering in accordance with one or more embodiments; and

FIG. 9 illustrates a flowchart of a series of acts in a method of context retrieval for document question answering using a knowledge graph in accordance with one or more embodiments;

FIG. 10 illustrates a block diagram of an exemplary computing device in accordance with one or more embodiments.

### DETAILED DESCRIPTION

One or more embodiments of the present disclosure include a document management system which can generate a graph of documents. The graph of documents links related document chunks (e.g., sentences, phrases, paragraphs, etc.) and may be used to provide context for a document question answering (DQA) system. Conventional question answering systems typically use large language models (LLMs). These systems receive a context (e.g., the document or documents being queried) as part of the input prompt. However, these models have prompt size limits, which set a maximum number of tokens which can be input to the models. As such, either the model must rely on only portions of a document to generate an answer, or the documents must be processed in chunks.

In an attempt to address these issues, some conventional systems have implemented a MapReduce technique, where the document(s) are broken up into chunks and an answer is obtained for each chunk. These per-chunk answers are then combined to generate a final answer. Other conventional systems have implemented a Refine technique, where chunks of the document(s) are processed in sequence. An answer is generated for the first chunk, and then attempts are made to refine the answer with each subsequent chunk until the entire document has been processed. Although such techniques typically generate accurate results, they require significant processing resources, as multiple inference calls must be made to generate an answer. Additionally, these approaches can result in less accurate answers and lead to further confusion. For example, in processing so much content, the LLM is more likely to hallucinate, making the results less reliable.

Another existing technique is called stuffing, where a retrieval process is used to attempt to find relevant chunks of the document(s) and only process those relevant chunks. While this reduces the amount of content being processed, the accuracy and reliability of the technique becomes dependent on how well the retrieval process works. For example, a keyword search may identify some relevant chunks while missing others, or misidentify some chunks as relevant when they are not.

To address these and other deficiencies in conventional systems, the document management system of the present disclosure first generates a graph of the document(s) being processed. The graph is generated by dividing the documents being processed into chunks. The similarity of chunks (e.g., based on similarity metric, keywords, etc.) can then be computed. In some embodiments, structural information (e.g., tables, pages, etc.) may also be incorporated into the graph. The resulting graph represents the relationships (e.g., similarity) between chunks of the document(s). Document question answering (DQA) may then be performed on the documents using the graph to form a context for answering the question.

In some embodiments, when a question is received, the graph may be traversed to determine an answer for a given question. Conventional graph traversal (e.g., depth first search, breadth first search, etc.) is likely to incorporate irrelevant chunks, increasing the likelihood of an incorrect or hallucinated answer. Instead, embodiments traverse the graph using a passage generator which has been trained to predict the next best chunk in the graph based on the question and the chunks that have already been processed. This generated chunk can be compared to the available chunks within the current search space (e.g., those chunks that are linked in the graph to the current node). The traversal may proceed to the node that is most similar to the generated chunk. This provides for a more efficient traversal of the graph compared to question-agnostic graph search techniques and results in fewer irrelevant document chunks being identified. Once the appropriate context has been retrieved, then DQA techniques may be used to answer the question based on the context, and the answer can be returned to the user.

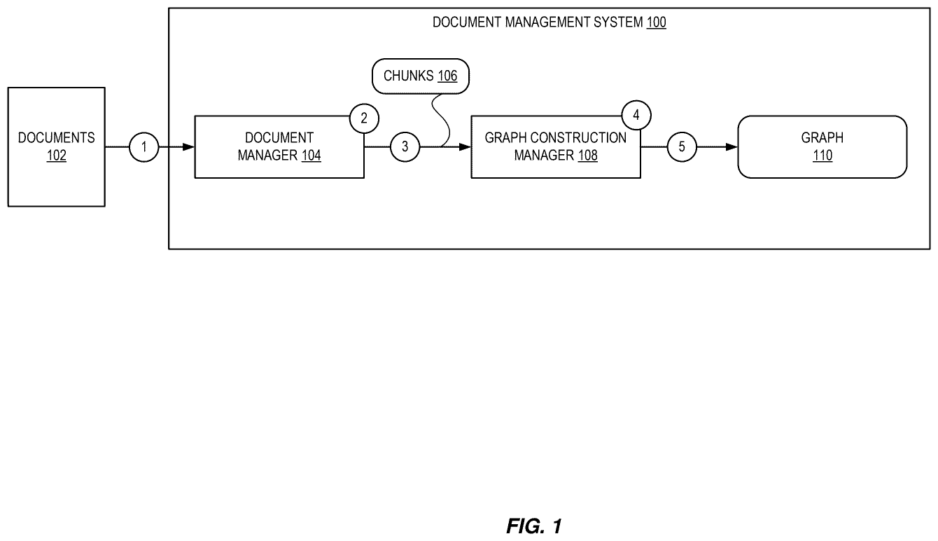

FIG. 1 illustrates a diagram of a process of knowledge graph construction in accordance with one or more embodiments. As shown in FIG. 1, a document management system 100 can construct a graph (also referred to as a knowledge graph or document graph) from a set of documents 102. In some embodiments, the document management system 100 may be implemented as part of a document viewing/editing application, document authoring application, and/or suite of applications that include document management functions. In various embodiments, the document management system may be executed locally, on a client device, remotely, on a server device accessible to one or more client devices over one or more networks, or portions of the document management system may execute locally on the client device and remotely on one or more server devices.

At numeral 1, one or more documents 102 may be received by the document management system. For example, a user may open the documents using the document management system 100. In some embodiments, this may include opening copies of the documents accessible to the document management system 100 (e.g., at one or more storage locations on a client device, via one or more networks, accessible via a storage service, etc.). At numeral 2, the documents 102 are received by a document manager 104 which is responsible for dividing the documents 102 into chunks 106. The chunks 106 may include phrases, sentences, paragraphs, or other subsets of contiguous words (e.g., tokens) extracted from the document(s). At numeral 3, the chunks 106 are provided to a graph construction manager 108.

Graph construction manager 108 is responsible for building a graph that links the chunks 106 together based on common characteristics. At numeral 4, in some embodiments, the graph construction manager builds a graph 110 of document chunks based on their common characteristics. For example, chunks may be linked if they share common keywords. By identifying common keywords, the graph 110 can be constructed such that it captures logical transitions among the various chunks. In some embodiments, in addition to content-based graph construction, the graph construction manager 108 further adds nodes to the graph which capture other information, such as structural information, metadata, etc. This may include page numbers, references, hyperlinks, hyperlinked data, table elements, etc. At numeral 5, the resulting graph 110 which represents the chunks 106 of documents 102 is output. As discussed, this graph 110 may be used to determine an appropriate context for responding to document queries.

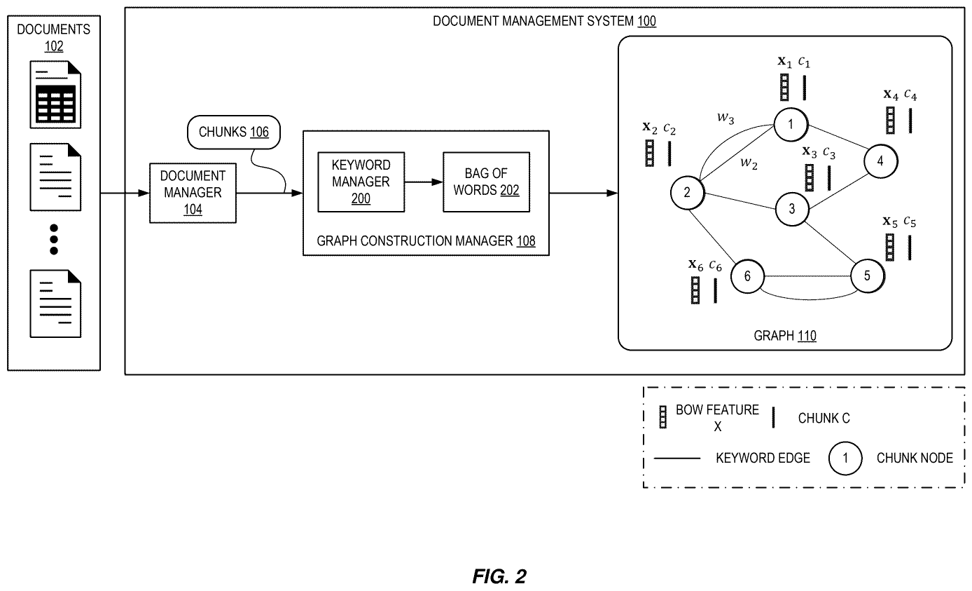

FIG. 2 illustrates a diagram of knowledge graph construction based on keywords in accordance with one or more embodiments. As discussed, answering questions often requires knowledge from chunks across different documents. Initially, each document 102 Dᵢ∈D is divided into chunks 106 by document manager 104. In some embodiments, document manager 104 may implement natural language processing (NLP) techniques to divide an input document into chunks. In some embodiments, the chunks may represent individual sentences, paragraphs, clauses, or other sets or subsets of document text content. One example of such NLP techniques may be provided by a library such as spaCy, though other suitable techniques may be known to one of ordinary skill.

In some embodiments, the NLP techniques may be implemented using one or more neural networks. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

Each chunk corresponds to a node in the resulting graph G 110 and collectively there are | [symbol] | nodes in the graph G. For example, let G=( [symbol] , ε) be the graph connecting different chunks of documents 102 with the node set

$$V = {\{ {v}_{i} \}}_{i = 1}^{n}$$

as chunks (e.g., paragraphs/sentences/entities, etc.) and the edge set ε⊆ [symbol] denoting the rational connections among different passage chunks (e.g., semantic/lexical similarity, common keywords, etc.). Specifically, vᵢ is the i^{th} passage chunk and

$${e}_{i}^{j}$$

is the connection between the passage chunk vᵢ and vⱼ. Furthermore, we denote the node features as

$$X = {\{ {X}_{i} \}}_{i = 1}^{n}$$

where [symbol] corresponds to tokens of the passage chunk vᵢ. Let

$$𝒮 = {\{ {𝒮}_{m} \}}_{m}^{M} = 1$$

be the observed chunk flows with m^{th} flow as

$${𝒮}_{m} = {\{ {s}_{i}^{m} \}}_{i = 0}^{\vert {𝒮}_{m} \vert} ,$$

which initiates from a question and traverses along some nodes (e.g., chunks) to form the grounding contexts for answering the question.

In some embodiments, the graph construction manager 108 builds the graph 110 of chunks based on whether two passage chunks share common keywords. For example, for each document Dᵢ, informative tokens such as ‘NOUN’ and ‘PROPN’ are kept, and then keyword manager 200 is used to extract the most important keywords from each document and its title. In some embodiments, keyword manager 200 may implement TF-IDF to identify the most important keywords from the documents. In some embodiments, the keyword manager 200 uses the extracted keywords to form a word space

$$𝒲 = {\{ {w}_{i} \}}_{i = 1}^{\vert 𝒲 \vert}$$

and construct the bag-of-word (BOW) 202 features Xᵢ∈ [symbol] for each passage chunk vᵢ∈ [symbol] where Xᵢⱼ=1 indicates the i^{th} passage chunk has the j^{th} keyword and Xᵢⱼ=0 otherwise. Common keywords usually indicate strong logical signals bridging different passage chunks/nodes in answering multi-hop questions. Therefore, edges are added between nodes based on whether their corresponding passage chunks share certain common keywords. Mathematically, assuming the adjacency matrix of G as A= [symbol] Aᵢⱼₖ=1 indicates the i^{th} and j^{th} passage chunks share k^{th} common keyword, which essentially forms a multiplex graph 110.

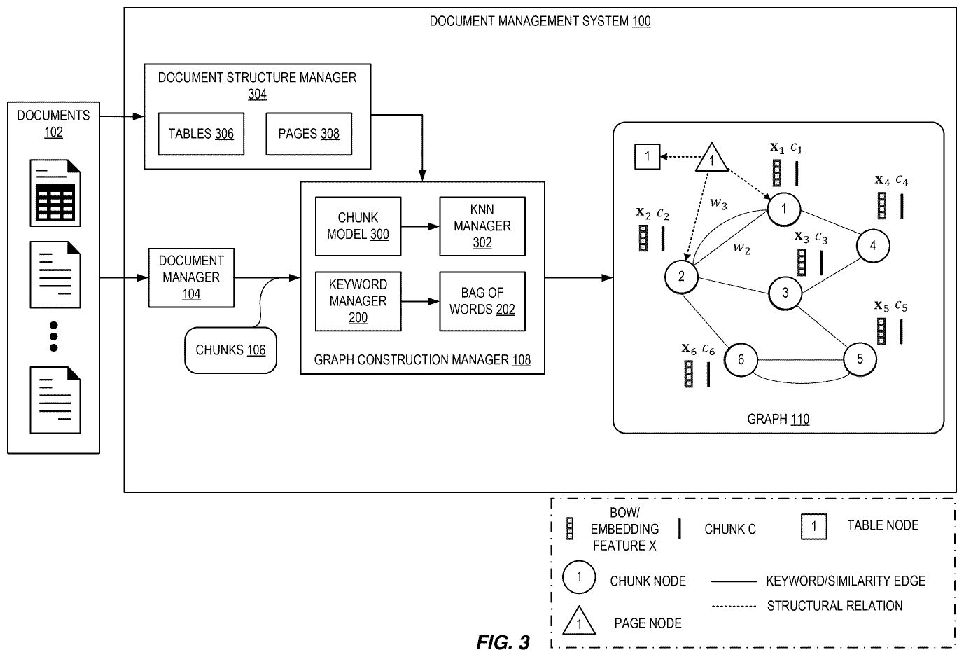

FIG. 3 illustrates a diagram of knowledge graph construction based on keywords, document embeddings, or document structure in accordance with one or more embodiments. As discussed above, a graph 110 may be constructed by graph construction manager 108 based on common keywords (e.g., by keyword manager 200 using bag of words representation 202. Alternatively, in some embodiments, the graph 110 may be constructed using k nearest neighbors (KNN). For example, the graph construction manager may include a chunk model 300. Chunk model 300 may be a neural network which receives a chunk 106 and generates an embedding that represents the chunk. In some embodiments, the chunk model 300 may be a large language model (LLM) or other model that has been trained to generate an embedding in an embedding space that represents the input chunk. Once embeddings for the chunks have been generated by chunk model 300, KNN manager 302 can construct graph 110. For example, a pair of nodes is connected with an edge if the embeddings corresponding to those nodes are similar (e.g., the k^{th} most similar nodes).

Besides the content-based graph construction as described above, embodiments also enable the enhancement of the graph with other node types such as structural information or metadata. For example, structural nodes may include information such as page numbers, references, content behind hyperlinks, table elements (column number, column title, header, description, etc.), or section titles, etc. Furthermore, metadata nodes can add author information, change logs, etc. As shown in FIG. 3, document structure manager 304 can identify structural information from the documents. In the example of FIG. 3, the document structure manager is specifically configured to identify tables 306 and page numbers 308 embedded within the documents. These may then be added to the graph as their own nodes and linked via edges to related chunks. For example, page 1 of a document includes table 1 and chunks 1 and 2 of the document are likewise associated with page 1 of the document.

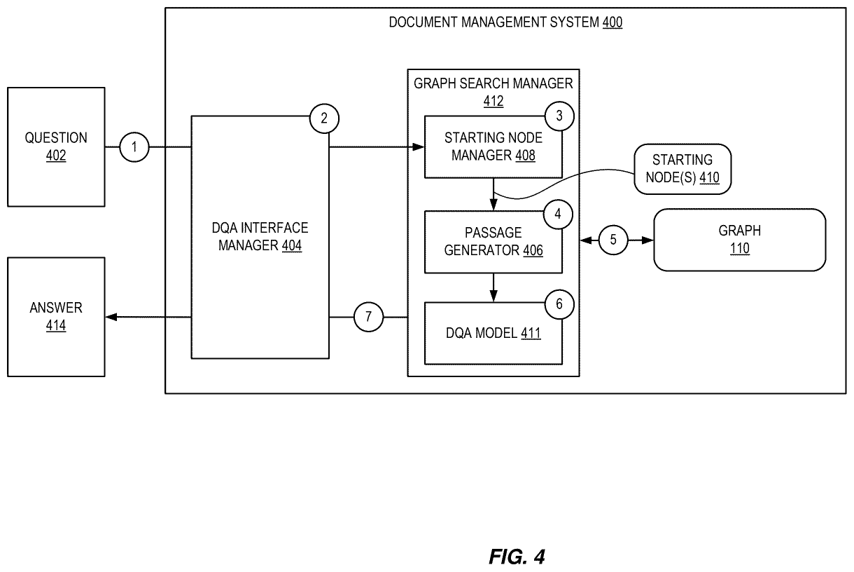

FIG. 4 illustrates a diagram of a process of document question answering using a document knowledge graph for context retrieval in accordance with one or more embodiments. As shown in FIG. 4, document management system 400 may enable document question answering. For example, the document management system 400 may enable a user to view, edit, or otherwise interact with one or more documents. As discussed further below, this may include providing a user interface that includes a document question answer (DQA) interface through which the user may submit queries related to the documents and receive answers to those queries.

For example, at numeral 1, the user may submit a question 402 to the document management system 400 via DQA interface manager 404. In some embodiments, the DQA interface manager 404 may provide a text-based interface, such as a text box or other user interface element through which the user enters their question. Additionally, or alternatively, the DQA interface manager 404 may provide other interfaces such as a voice to text interface, etc. At numeral 2, the DQA interface manager 404 passes the question 402 to starting node manager 408.

At numeral 3, starting node manager 408 determines one or more starting nodes by finding the top-k passage chunks. For example, the top-k passage chunks may be determined based on keywords extracted from the question and/or based on embedding similarity between an embedding generated for the question and embeddings generated for each chunk of the documents. The top-k passage chunks are then searched, such as using a beam search or other search algorithm, to determine the starting node of the graph to be used.

With the starting node(s) 410 identified, the graph can then be traversed to determine an answer to the question. At numeral 4, graph search manager 412 can start at the starting node(s) and traverse the graph 110, at numeral 5, to determine the chunks to be used to determine the answer 414. As discussed further below, a passage generator 406 can be used to predict a next passage. The passage generator 406 may include a language model, such as a large language model, which has been trained on question answer sequences (e.g., based on observed question answer sequences, synthetically generated sequences, etc.). This allows for the passage generator to learn the logical relationships between questions, chunks of text, and answers.

For example, the passage generator may be prompted to generate a passage that would answer the question given the context(s) that have already been retrieved. The passage generator then generates a chunk of text. The content of the generated text may be inaccurate, as the passage generator does not have pre-existing knowledge of every possible question. However, because the passage generator has been trained on question answer sequences, the logical connections between the context and the generated chunk are likely to be similar to a chunk that includes the answer.

The generated chunk can be used to determine the next chunk in the graph to select (e.g., the next chunk that is most similar to the generated chunk). For example, the search space in the graph is limited to the nodes that are connected to the current node. The traversal may then take the form of comparing the candidate next nodes within the search space to the generated chunk. The most similar candidate next node can be selected as the next node. Traversal can thus be performed iteratively, moving from node to node based on the predicted next node by the passage generator. The chunk corresponding to each node that has been traversed is added to the context. In some embodiments, traversal can continue until the context is full, the graph has been fully traversed, and/or an end condition has been reached (e.g., based on latency, a fixed number of steps, etc.). At numeral 6, a document question answering model 411 can process the retrieved context to extract the answer 414. At numeral 7, the answer can be returned to the user via the DQA interface manager 404.

As discussed, the edges in the constructed graph encode the logical connections between passage chunks, one way to form a context for question answering is to perform graph traversal to search for the optimal passage chunks for answering a question. However, directly performing a question-agnostic traversal such as DFS/BFS is very likely to incorporate passages that are irrelevant to the given question and the current context. In order to enable traversal to adaptively select the right passage, embodiments train a passage generator 406 for predicting the next passage based on the observed question-passage sequences. If the passage generator can successfully predict the correct next passage, it will have the capability of capturing the inherent logical connections among different passages that are unique to the current question and context.

Question-passage sequences may include a question, one or more chunks related to the question, and a resulting answer determined from the chunks. The structure of the sequences may vary depending on the types of questions that are supported. For example, a bridging question analysis may link from one chunk to another to serially to find the answer to the question. For instance, a question may be “In what year was the composer of the Simpson's Theme born?” This may result in identifying a first chunk of a document that indicates who the composer of the theme is, followed by identifying a second chunk of a document that indicates the answer of when the composer was born. This is an example of a bridging question analysis. Alternatively, a comparing question analysis may identify multiple chunks related to the question and compare the chunks to determine the answer. An example question may be “were Person A and Person B of the same nationality?” This may result in identifying a first chunk of a document related to person A and a second chunk of a document related to person B. These chunks can then be compared to determine the answer to the question.

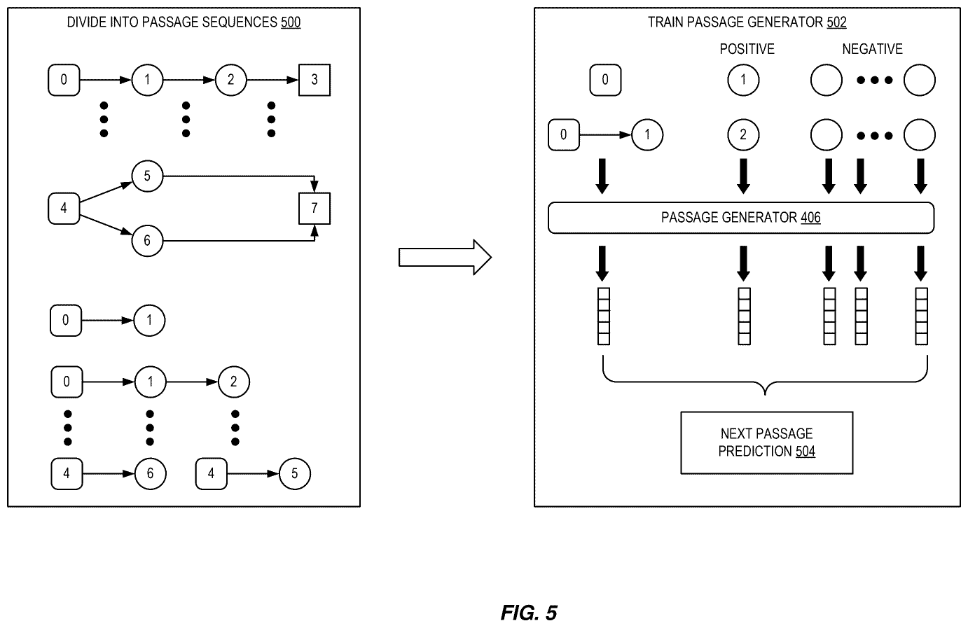

To train passage generator 406, embodiments first pre-process the observed question-passage sequences by sequentially breaking each sequence at each of its intermediate transitions. An example of this is shown in FIG. 5. As shown at 500, a number of question passage sequences may be divided into passage sequences. For example, a first question passage sequence may include question node 0 which links to chunk node 1, which links to chunk node 2, which links to answer node 3. A second question passage sequence may include question node 4, chunk nodes 5 and 6, and answer node 7. These can be broken down into sequences at each transition. For example, as shown in FIG. 5, the first question passage sequence can be broken down into question node 0 to chunk node 1 and question node 0 to chunk node 1 to chunk node 2. Similarly, the second question passage sequence can be broken down into question node 4 to chunk node 5 and question node 4 to chunk node 6.

These sequences may then be used to train the passage generator g by maximizing the likelihood of observing the processed question-passage sequences

$$𝒮 = {\{ {𝒮}_{m} \}}_{m = 1}^{ℳ} .$$

Specifically, as shown at 502 in FIG. 5, for each sequence i, the likelihood is modeled as the probability of transitioning to the j^{th} passage chunk

$${s}_{j}^{i}$$

given the already traversed i−1 passage chunks

$$\{ {s}_{0}^{i} , … , {s}_{j - 1}^{i} \} ,$$

$$P ( S \vert {Θ}_{ℊ} ) = {\prod }_{i = 1}^{M} {\prod }_{j = 1}^{\vert {S}_{m} \vert} P ( {s}_{j}^{i} \vert {s}_{0}^{i} , … , {s}_{j - 1}^{i} ) ,$$

where Θ_{g} is the parameter of the dense passage encoder g and

$${s}_{0}^{i}$$

is typically the question. At each step j, a new question embedding is constructed based on existing traversed passages as

$${q}_{j}^{i} = g ( {s}_{j}^{i} )$$

and the next passage embedding as

$${p}_{j}^{i} = g ( {s}_{0}^{i} , … , {s}_{j - 1}^{i} ) ,$$

then the likelihood is calculated as:

$$P ( {s}_{j}^{i} \vert {s}_{0}^{i} , … , {s}_{j - 1}^{i} ) = \frac{exp ( 〈 {q}_{j}^{5} , {p}_{j}^{i} 〉 )}{{\sum }_{s ∈ ℋ} exp ( 〈 {q}_{s} , {p}_{j}^{i} 〉 )}$$

where qₛ=g(s) is the embedding of the negative sampled passage chunk s and <·, ·> is the inner product between the question and the passage embeddings. In various embodiments, the passage the passage generator may be implemented as a language model, such as RoBERTa.

Given the graph 110 that imposes the prior logical constraints between any pair of chunks, the passage generator 406 is used to adaptively traverse the neighbors based on the input question and passages that have already been visited, which essentially composes an adaptive path generator. For example, given a question q, starting node(s) are located in the graph by finding the top-k chunks based on the question (e.g., the top k chunks based on keywords, embedding similarity, etc.). Graph search manager 412 then iteratively searches (e.g., such as using a beam search) the graph where the search space is limited to the neighbors presented by the constructed prior graph. As discussed, the passage generator 406 may be used to generate a predicted next chunk based on the question and any previously retrieved context (e.g., other chunks that have already been traversed). The generated chunk can be compared to the chunks in the search space (e.g., based on keywords, TF-IDF, embedding similarity, etc.). The most similar chunk in the search space may then be retrieved. The context can then be analyzed by DQA model 411 to determine whether an answer has been found. If so, the answer is returned at numeral 6. If not, the search continues iteratively until the answer is found or the entire graph has been traversed, the context is filled, etc.

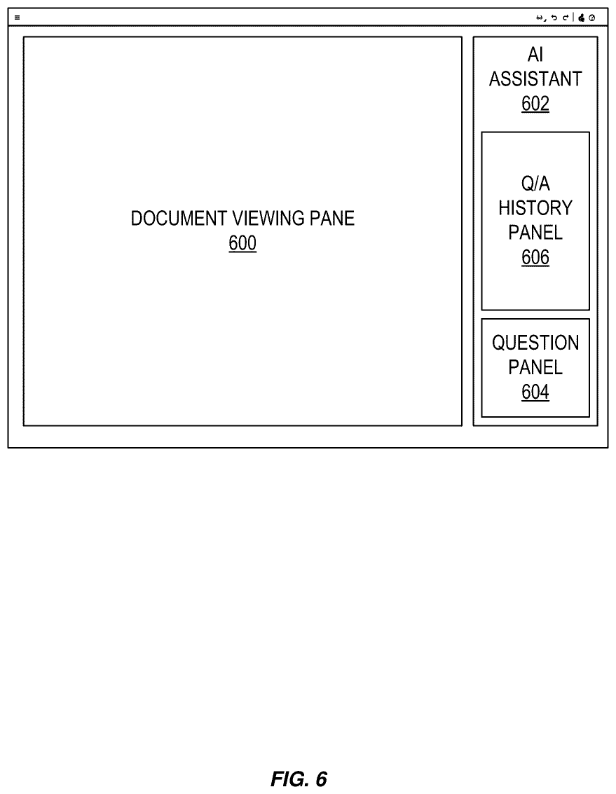

FIG. 6 illustrates an example of a user interface for document question answering in accordance with one or more embodiments. As shown in FIG. 6, a graphical user interface (GUI) for a document question answering system may include a document viewing pane 600. The document viewing pane 600 may enable the user to open one or more documents, such as portable document format (PDF) documents, or other documents. In some embodiments, the document viewing pane 600 may enable the user to view multiple documents. Additionally, in some embodiments, the document viewing pane 600 may enable the user to create and/or edit documents. The document question answering system may be configured to open documents stored locally, or which may be accessed over one or more networks, such as the Internet.

The GUI may also include an AI assistant pane 602 which provides one or more artificial intelligence-driven tools which may be used by the user as the user reads the documents. For example, the AI assistant panel 602 may include a document question answering interface which may include a question answer history panel 606 and a question panel 604. The user may enter a question related to the documents open in the viewing pane into question panel 604. The techniques described herein may then be applied to determine an answer to the question which is then returned to the user. For example, a graph of the documents open in the document viewing pane 600 may be generated. In some embodiments, the user may be given the option to select which documents are to be included in the construction of the graph (e.g., to exclude one or more open documents and/or add documents that are not yet open). Once the graph is created, the answer to the question may be determined by traversing the graph, as discussed herein. The answer can be returned to the user via the question panel 604 and/or the question answer history panel 606.

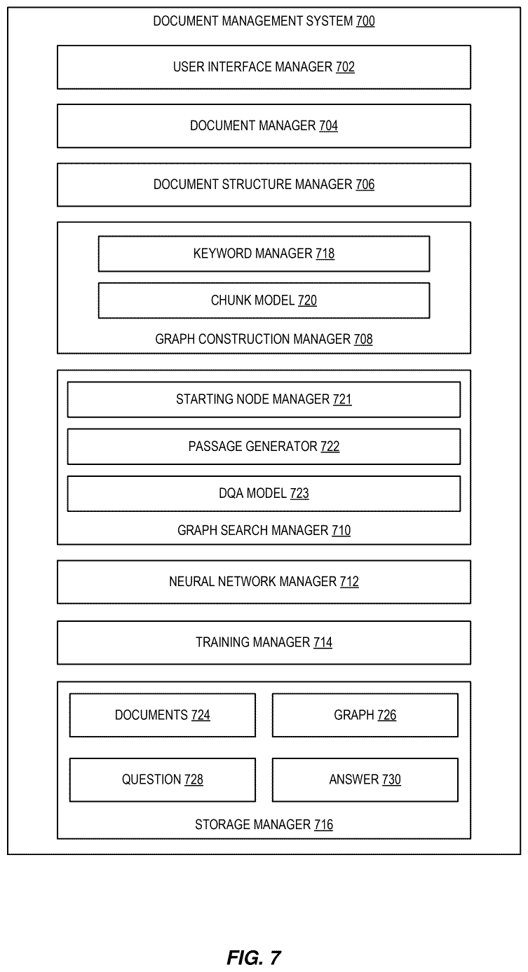

FIG. 7 illustrates a schematic diagram of document management system (e.g., “document management system” described above) in accordance with one or more embodiments. As shown, the document management system 700 may include, but is not limited to, user interface manager 702, document manager 704, document structure manager 706, graph construction manager 708, graph search manager 710, neural network manager 712, training manager 714, and storage manager 716. The graph construction manager 708 includes a keyword manager 718 and a chunk model 720. The graph search manager 710 includes a starting node manager 721, a passage generator 722, and a DQA model 723. The storage manager 716 includes documents 724, graph 726, question 728, and answer 730.

As illustrated in FIG. 7, the document management system 700 includes a user interface manager 702. For example, the user interface manager 702 allows users to open and view documents and provide questions to the document management system 700. In some embodiments, the user interface manager 702 provides a user interface through which the user can open documents 724 stored locally, as discussed above. Alternatively, or additionally, the user interface may enable the user to open documents from a remote storage location (e.g., by providing an address (e.g., a URL or other endpoint) associated with a document source).

Additionally, the user interface manager 702 allows users to ask questions related to the documents 724 for the document management system 700 to answer. For example, the user may ask a question 728 about the documents or based on the contents of the documents, questions which may be answered by the contents of the documents, etc. The document management system 700 can then determine an answer 730 to the question 728, as discussed herein, and generate an answer to the question. In some embodiments, the user interface manager 702 enables the user to view the resulting answer and ask additional related or unrelated questions.

As illustrated in FIG. 7, the document management system 700 includes a document manager 704. The document manager 704 can receive an initial request to view one or more documents. For example, the user may open a document (e.g., a local or remote copy of a document, a link to a copy of the document, etc.). As discussed, in some embodiments, the document manager 704 can cause the documents to be displayed to the user, e.g., via user interface manager 702. Additionally, in some embodiments, the document manager 704 is responsible for dividing the document into chunks. As discussed, these chunks may include portions of text from the document, such as clauses, sentences, paragraphs, sections, or other quantities of text.

As illustrated in FIG. 7, the document management system 700 also includes a document structure manager 706. As discussed, document structure manager 706 is responsible for extracting structure and metadata information from the documents. For example, the document structure manager 706 may determine page numbers, references, hyperlinks, hyperlinked data, table elements, etc. associated with the documents.

As illustrated in FIG. 7, the document management system 700 also includes a graph construction manager 708. The graph construction manager 708 can generate a graph 726 which includes nodes corresponding to each chunk from document manager 704. In some embodiments, structure and/or metadata nodes may also be included which represent the structure or metadata extracted from the documents by document structure manager 706. The nodes are connected by edges that represent logical connections between the chunks. These edges may be determined based on similarity between the chunks. For example, in some embodiments, a keyword manager 718 can be used to determine keywords representing the chunks and chunks represented by the same or similar keywords may be connected by edges. Alternatively, a chunk model 720 may be used to generate an embedding representing each chunk. These embeddings may be used to identify similar chunks (e.g., cosine similarity between embeddings in embedding space, or other similarity techniques). Similar chunks may be connected by edges to form the graph. The graph construction manager 708 can also enhance the graph by linking structure and metadata nodes to the appropriate chunks. For example, chunks corresponding to a particular page of a document may be linked to the same page node, etc.

As illustrated in FIG. 7, the document management system 700 also includes a graph search manager 710. The graph search manager 710 is responsible for traversing the document graph in response to receipt of a question 728 to determine a corresponding answer 730 based on the documents 724. As discussed, question-agnostic traversal of the graph can lead to retrieving unrelated content from the documents. Accordingly, the graph search manager 710 performs a more intelligent traversal that is based on the question and the context information that has already been retrieved. Initially, starting node manager 721 can identify a node of the graph to start the search based on the question. In some embodiments, this may include determining the node most similar to the question, e.g., using TF-IDF or other techniques.

From the starting node, the search space is restricted by the structure of the graph to connected nodes. In some embodiments, a passage generator 722 is used to predict the next chunk. For example, the passage generator may be a language model trained to generate a chunk of text based on an input question and the context that has already been retrieved (e.g., the chunks of text corresponding to the nodes that have been traversed). As discussed, the generated chunk is generated not for the accuracy of its content, but for the likely logical features of the generated chunk. For example, if the question is related to the birthdate of a person, then a chunk that answers the question likely includes a birthdate. As such, the generated chunk can be compared to the chunks in the search space, and the most similar chunk chosen as the next chunk in the traversal. The context for answering the question can therefore be intelligently retrieved by the graph search manager using the passage generator 722 and the graph 726. Once the context has been retrieved, it can be used by the DQA model 723 to extract the answer 730 from the context. The answer 730 can then be returned to the user.

In some embodiments, the graph search manager 710 can traverse the document graph based on the structure or metadata nodes to identify metadata to answer a given question. As discussed, the document graph may represent page numbers, tables, or other structure or metadata extracted from the document(s). For example, some questions may be associated with specific structure or metadata (e.g., a question may specify particular pages, tables, etc.). In such instances, the traversal may be performed in whole, or in part, using the structure or metadata nodes to identify relevant context for answering the question.

As illustrated in FIG. 7, the image generation system 700 also includes a neural network manager 712. Neural network manager 712 may host a plurality of neural networks or other machine learning models. For example, the various models referenced in document management system 700, e.g., chunk model 720, passage generator 722, etc., may be hosted by neural network manager 712 or each may be hosted by its own neural network manager instance. The neural network manager 712 may include an execution environment, libraries, and/or any other data needed to execute the machine learning models. In some embodiments, the neural network manager 712 may be associated with dedicated software and/or hardware resources to execute the machine learning models. Although depicted in FIG. 7 as a single neural network manager 712, in various embodiments the neural networks may be hosted in multiple neural network managers and/or as part of different components. For example, each model can be hosted by their own neural network manager, or other host environment, in which the respective neural networks execute, or the models may be spread across multiple neural network managers depending on, e.g., the resource requirements of each model, etc.

As illustrated in FIG. 7 the image generation system 700 also includes training manager 714. The training manager 714 can teach, guide, tune, and/or train one or more neural networks. In particular, the training manager 714 can train a neural network based on a plurality of training data. For example, as discussed, passage generator 722 may be trained to predict a next chunk of text based on a question and context. Additionally, the model(s) may be further optimized using loss functions, as discussed above, by backpropagating gradient descents. More specifically, the training manager 714 can access, identify, generate, create, and/or determine training input and utilize the training input to train and fine-tune a neural network. For instance, the training manager 714 can train the model(s), end-to-end, as discussed above.

As illustrated in FIG. 7, the document management system 700 also includes the storage manager 716. The storage manager 716 maintains data for the document management system 700. The storage manager 716 can maintain data of any type, size, or kind as necessary to perform the functions of the document management system 700. The storage manager 716, as shown in FIG. 7, includes the documents 724. The documents 724 can include a plurality of digital documents that include text data, as discussed in additional detail above. The storage manager may manage access to the documents from remote or local storage location(s), versioning of the documents as changes are made, etc.

As further illustrated in FIG. 7, the storage manager 716 also includes graph 726. As discussed, the documents 724 may be broken down into chunks by the document management system. These chunks may include clauses or sentences, paragraphs, sections or other portions of text. The graph is then constructed by linking the chunks together based on relationships between the chunks (e.g., keywords, embedding similarity, etc.). The graph 726 can then be utilized by the document management system 700 to answer questions about the documents. For example, as discussed, when a question is received a starting node in the graph may be identified. The graph is then traversed from the starting node until a sufficient context has been retrieved such that an answer to the question can be determined (e.g., by DQA model 723).

The storage manager 716 may also include question data 728 and answer data 730. The question data 728 may include a text-based question received from a user via a user interface provided by user interface manager 702. The question may be received via an input device such as a keyboard, a microphone (e.g., voice to text), or other input type. In various embodiments, the question data 728 may include multiple questions which are maintained in a history by the storage manager. The questions 728 are then processed by the document management system 700 to determine answers 730 related to the documents 724. As discussed above, this may include analyzing a graph of the documents to determine the answer(s) to the question(s). Similarly to the question data, the answer data may include multiple answers to multiple questions. These answers may be maintained in a history (either the same history as the questions or in a separate history).

Each of the components 702-716 of the document management system 700 and their corresponding elements (as shown in FIG. 7) may be in communication with one another using any suitable communication technologies. It will be recognized that although components 702-716 and their corresponding elements are shown to be separate in FIG. 7, any of components 702-716 and their corresponding elements may be combined into fewer components, such as into a single facility or module, divided into more components, or configured into different components as may serve a particular embodiment.

The components 702-716 and their corresponding elements can comprise software, hardware, or both. For example, the components 702-716 and their corresponding elements can comprise one or more instructions stored on a computer-readable storage medium and executable by processors of one or more computing devices. When executed by the one or more processors, the computer-executable instructions of the document management system 700 can cause a client device and/or a server device to perform the methods described herein. Alternatively, the components 702-716 and their corresponding elements can comprise hardware, such as a special purpose processing device to perform a certain function or group of functions. Additionally, the components 702-716 and their corresponding elements can comprise a combination of computer-executable instructions and hardware.

Furthermore, the components 702-716 of the document management system 700 may, for example, be implemented as one or more stand-alone applications, as one or more modules of an application, as one or more plug-ins, as one or more library functions or functions that may be called by other applications, and/or as a cloud-computing model. Thus, the components 702-716 of the document management system 700 may be implemented as a stand-alone application, such as a desktop or mobile application. Furthermore, the components 702-716 of the document management system 700 may be implemented as one or more web-based applications hosted on a remote server. Alternatively, or additionally, the components of the document management system 700 may be implemented in a suite of mobile device applications or “apps.”

As shown, the document management system 700 can be implemented as a single system. In other embodiments, the document management system 700 can be implemented in whole, or in part, across multiple systems. For example, one or more functions of the document management system 700 can be performed by one or more servers, and one or more functions of the document management system 700 can be performed by one or more client devices. The one or more servers and/or one or more client devices may generate, store, receive, and transmit any type of data used by the document management system 700, as described herein.

In one implementation, the one or more client devices can include or implement at least a portion of the document management system 700. In other implementations, the one or more servers can include or implement at least a portion of the document management system 700. For instance, the document management system 700 can include an application running on the one or more servers or a portion of the document management system 700 can be downloaded from the one or more servers. Additionally or alternatively, the document management system 700 can include a web hosting application that allows the client device(s) to interact with content hosted at the one or more server(s).

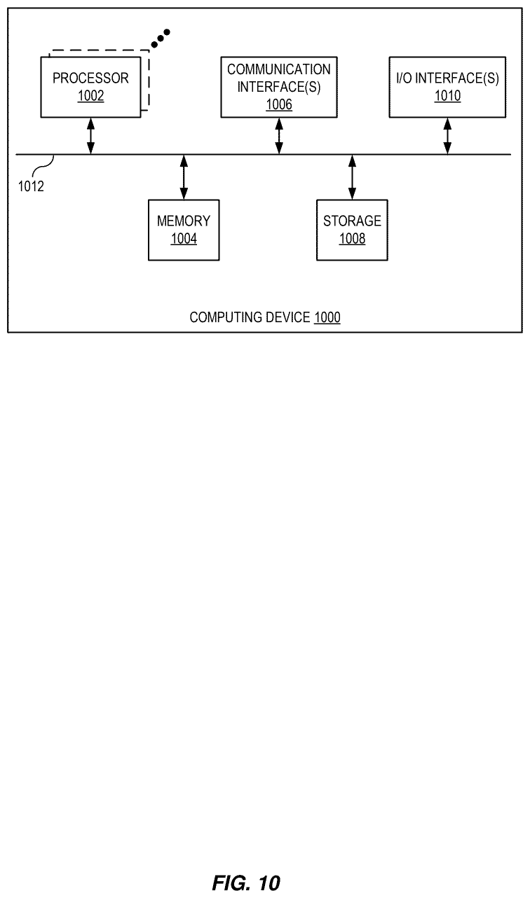

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

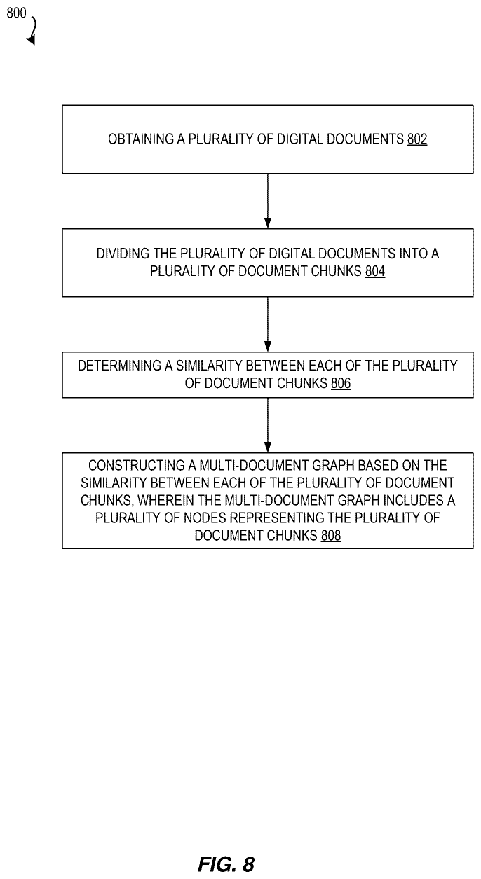

FIGS. 1-7, the corresponding text, and the examples, provide a number of different systems and devices that enable context retrieval for document question answering using a knowledge graph. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of knowledge graph generation for context retrieval for document question answering in accordance with one or more embodiments. In one or more embodiments, the method 800 is performed in a digital medium environment that includes the document management system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining a plurality of digital documents. As discussed, in some embodiments, the user can open and view various digital documents, such as portable document format (PDF) or digital documents of other formats. The digital documents may include text documents or may include other content, such as charts, tables, etc.

As illustrated in FIG. 8, the method 800 includes an act 804 of dividing the plurality of digital documents into a plurality of document chunks. In some embodiments, the text content of the documents may be divided into various portions (e.g., chunks). For example, the chunks may include clauses, sentences, paragraphs, sections, or other portions. In some embodiments, each chunk is the same type of portion (e.g., every chunk is a sentence, or every chunk is a paragraph). Alternatively, in some embodiments, each chunk may include the same, or a similar, quantity of contiguous text.

As illustrated in FIG. 8, the method 800 includes an act 806 of determining a similarity between each of the plurality of document chunks. In some embodiments, determining the similarity may include determining one or more keywords associated with each document chunk. For example, various techniques, such as TF-IDF, bag-of-words, or other techniques, may be used to identify the keywords. In some embodiments, determining the similarity may include generating, by a chunk model, a plurality of embeddings, wherein each embedding corresponds to a document chunk. As discussed, the chunk model may include a neural network trained to generate an embedding representation of an input text. The similarity can be determined between each of the plurality of chunks based on a similarity between each of the corresponding plurality of embeddings.

As illustrated in FIG. 8, the method 800 includes an act 808 of constructing a multi-document graph based on the similarity between each of the plurality of document chunks, wherein the multi-document graph includes a plurality of nodes representing the plurality of document chunks. The multi-document graph may then be constructed based on the similarity. For example, in some embodiments, constructing the graph includes connecting pairs of nodes representing the document chunks with at least one shared keyword with an edge to form the multi-document graph.

In some embodiments, the structure of the documents may also be represented in the multi-document graph. For example, representing the structure may include determining structure content of the one or more digital documents and adding one or more structure nodes to the multi-document graph corresponding to the structure content. In some embodiments, the structure content includes at least one of page numbers and table content.

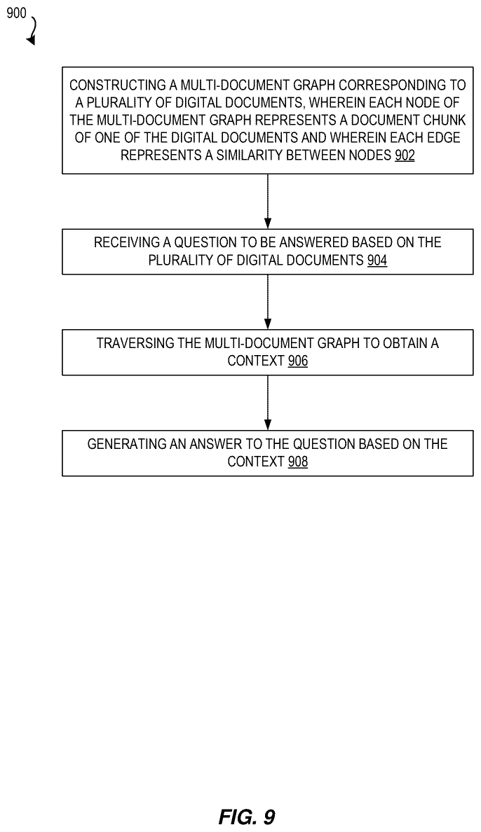

FIGS. 1-7, the corresponding text, and the examples, provide a number of different systems and devices that enable context retrieval for document question answering using a knowledge graph. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart of a series of acts in a method of context retrieval for document question answering using a knowledge graph in accordance with one or more embodiments. In one or more embodiments, the method 900 is performed in a digital medium environment that includes the document management system 700. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of constructing a multi-document graph corresponding to a plurality of digital documents, wherein each node of the multi-document graph represents a document chunk of one of the digital documents and wherein each edge represents a similarity between nodes. In some embodiments, constructing the multi-document graph includes dividing the plurality of digital documents into a plurality of document chunks and determining a similarity between each of the plurality of document chunks, wherein the similarity is based on keyword similarity or embedding similarity.

As illustrated in FIG. 9, the method 900 also includes an act 904 of receiving a question to be answered based on the plurality of digital documents. As discussed, a document question answering (DQA) interface may enable a user to enter a question (e.g., as a text query or other input).

As illustrated in FIG. 9, the method 900 also includes an act 906 of traversing the multi-document graph to obtain a context. In some embodiments, traversing the graph may include determining a starting node of the multi-document graph based on a similarity to the question. As discussed, the graph may be traversed intelligently using a passage generator which predicts the next text portion to answer the question. For example, traversing may include identifying a search space including nodes connected to a current node, predicting, using a passage generator, a next text chunk based on the question and a current context including already traversed nodes, and selecting a next node from the search space based on the predicted next text chunk.

As illustrated in FIG. 9, the method 900 also includes an act 908 of generating an answer to the question based on the context. For example, a DQA model may receive the context obtained from traversing the multi-document graph and the question and generate an answer to the question. The answer may then be returned to the user via the DQA interface.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the document management system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a plurality of digital documents;
dividing the plurality of digital documents into a plurality of document chunks;
determining a similarity between each of the plurality of document chunks; and
constructing a multi-document graph based on the similarity between each of the plurality of document chunks, wherein the multi-document graph includes a plurality of nodes representing the plurality of document chunks.

2. The method of claim 1, wherein determining a similarity between each of the plurality of document chunks, further comprises:
determining one or more keywords associated with each document chunk.

3. The method of claim 2, wherein constructing a multi-document graph based on the similarity between each of the plurality of chunks, further comprises:
connecting pairs of nodes representing the document chunks with at least one shared keyword with an edge to form the multi-document graph.

4. The method of claim 1, wherein determining a similarity between each of the plurality of document chunks, further comprises:
generating, by a chunk model, a plurality of embeddings, wherein each embedding corresponds to a document chunk; and
determining the similarity between each of the plurality of chunks based on a similarity between each of the corresponding plurality of embeddings.

5. The method of claim 4, wherein constructing a multi-document graph based on the similarity between each of the plurality of chunks, further comprises:
connecting pairs of nodes representing the document chunks determined to be similar with an edge to form the multi-document graph.

6. The method of claim 1, further comprising:
determining structure content of the plurality of digital documents, wherein the structure content includes at least one of page numbers and table content; and
adding one or more structure nodes to the multi-document graph corresponding to the structure content.

7. The method of claim 6, further comprising:
receiving a question to be answered based on the plurality of digital documents;
traversing the multi-document graph to obtain a context; and
generating an answer to the question based on the context.

8. The method of claim 1, wherein the context includes portions of text corresponding to a plurality of traversed nodes in the multi-document graph.

9. A system comprising:
a memory component; and
a processing device coupled to the memory component, the processing device to perform operations comprising:
obtaining a plurality of digital documents;
dividing the plurality of digital documents into a plurality of document chunks;
determining a similarity between each of the plurality of document chunks; and
constructing a multi-document graph based on the similarity between each of the plurality of document chunks, wherein the multi-document graph includes a plurality of nodes representing the plurality of document chunks.

10. The system of claim 9, wherein the operation of determining a similarity between each of the plurality of document chunks, further comprises:
determining one or more keywords associated with each document chunk.

11. The system of claim 10, wherein the operation of constructing a multi-document graph based on the similarity between each of the plurality of chunks, further comprises:
connecting pairs of nodes representing the document chunks with at least one shared keyword with an edge to form the multi-document graph.

12. The system of claim 10, wherein the operation of determining a similarity between each of the plurality of document chunks, further comprises:
generating, by a chunk model, a plurality of embeddings, wherein each embedding corresponds to a document chunk; and
determining the similarity between each of the plurality of chunks based on a similarity between each of the corresponding plurality of embeddings.

13. The system of claim 12, wherein the operation of constructing a multi-document graph based on the similarity between each of the plurality of chunks, further comprises:
connecting pairs of nodes representing the document chunks determined to be similar with an edge to form the multi-document graph.

14. The system of claim 10, wherein the processing device performs further operations comprising:
determining structure content of the plurality of digital documents; and
adding one or more structure nodes to the multi-document graph corresponding to the structure content.

15. The system of claim 14, further comprising:
receiving a question to be answered based on the plurality of digital documents;
traversing the multi-document graph to obtain a context; and
generating an answer to the question based on the context.

16. The system of claim 10, wherein the context includes portions of text corresponding to a plurality of traversed nodes in the multi-document graph.

17. A non-transitory computer-readable medium storing executable instructions, which when executed by a processing device, cause the processing device to perform operations comprising:
constructing a multi-document graph corresponding to a plurality of digital documents, wherein each node of the multi-document graph represents a document chunk of one of the digital documents and wherein each edge represents a similarity between nodes;
receiving a question to be answered based on the plurality of digital documents;
traversing the multi-document graph to obtain a context; and
generating an answer to the question based on the context.

18. The non-transitory computer-readable medium of claim 17, storing instructions that further cause the processing device to perform operations comprising:
determining a starting node of the multi-document graph based on a similarity to the question.

19. The non-transitory computer-readable medium of claim 17, wherein the operation of traversing the multi-document graph to obtain a context, further comprises:
identifying a search space including nodes connected to a current node;
predicting, using a passage generator, a next text chunk based on the question and a current context including already traversed nodes; and
selecting a next node from the search space based on the predicted next text chunk.

20. The non-transitory computer-readable medium of claim 17, wherein the operation of constructing a multi-document graph corresponding to the plurality of digital documents, further comprises:
dividing the plurality of digital documents into a plurality of document chunks; and
determining a similarity between each of the plurality of document chunks, wherein the similarity is based on keyword similarity or embedding similarity.
